(19) United States
(12) Patent Application Publication
(10) Pub. No.: US 2022/0039315 A1
(43) Pub. Date: Feb. 10, 2022

(54) HEAD OF A STRING TRIMMER, AND STRING TRIMMER COMPRISING SUCH A HEAD

(71) Applicant: ETUDES CONSTRUCTIONS METALLIQUES ET MECANIQUES, Millery (FR)

(72) Inventors: Pierre Gay, Millery (FR); René Hubert, Romagnieu (FR)

(21) Appl. No.: 16/988,084

(22) Filed: Aug. 7, 2020

(51) Int. Cl. A01D 34/416

(52) U.S. Cl. CPC A01D 34/416

(57) ABSTRACT

Head of a string trimmer, the head being rotatably trained around a spinning axis, the head including a wall including at least one eyelet, at least one bearing, which is received in the at least one eyelet and which defines a rotation axis, and at least one sub-assembly including a blocking member, and a cutting string that is held by the blocking member so as to extend outward of the wall radially to the spinning axis when the head is trained in rotation around the spinning axis, the at least one sub-assembly being received by the at least one bearing so that the at least one sub-assembly is rotatable without restriction around the rotation axis of the at least one bearing with respect to the wall.

### FIELD OF THE INVENTION

The present invention relates to a head of a string trimmer, and a string trimmer comprising such a head.

### BACKGROUND OF THE INVENTION

Among the various apparatus existing to cut grass, foliage or bushes, it is known to use a string trimmer, which comprise a spinning head with cutting strings.

The cutting strings, made for example out of nylon, are attached inside the spinning head at one end portion of the cutting string, while the other end portion of the cutting string extends through an eyelet outward the spinning head radially to a spinning axis of the spinning head. The spinning head rotates at high speed, so that the cutting strings become rigid under the centrifugal forces and become suitable to cut vegetation such as grass or bushes.

While mowing the lawn, as the cutting strings come into contact at high speed with obstacles such as the ground, stones or tree's roots, the strings are subject to intense wear. As the cutting strings are attached to the spinning head, the strings become worn always on the same side, leading to localized wear and early breakage of the strings. Although the material cost of a broken cutting string might be low, the environmental cost of a piece of cutting string left in the environment is becoming unacceptable.

There is therefore a need for an improved head for string trimmer, offering a longer service life for the cutting strings.

### SUMMARY OF THE DESCRIPTION

To this end, aspects of the invention pertains to a head of a string trimmer, the head being rotatably trained around a spinning axis, the head comprising:
a wall that is provided with at least one eyelet,
at least one bearing, which is received in the at least one eyelet and which defines a rotation axis,
at least one sub-assembly comprising a blocking member and a cutting string that is held by the blocking member so as to extend outward the wall radially to the spinning axis when the head is trained in rotation around the spinning axis, the at least one sub-assembly being received by the at least one bearing so that the sub-assembly is rotatable without restriction around the rotation axis of the at least one bearing with respect to the wall.

Thanks to the invention, as the cutting strings are free to rotate relatively the wall rather than being attached, when a string comes into contact with an obstacle, the string evades the impact and wears less. Furthermore, as the strings rotate around the rotation axis the abrasion is spread on all sides of the cutting strings. Localized wear is avoided, the risk of premature string break is reduced and the service life of the cutting string is longer.

In other words, the cutting strings have a second axis of free rotation when working. Favorably the strings have a shape generated by the two perpendicular centrifugal forces allowing the strings to lay down on grass or smooth ground and to evade easily by rotating when coming into contact with an obstacle they are unable to cut or move. The centrifugal force of the rotation movement tends to move the string away from the rotation axis, which presses the cutting string on the working surface and increases the cutting area. The cutting string incurs an abrasion that is spread on all sides of the cutting string. This abrasion favorably tapers the end portions of the cutting string, and the trimmer requires less rotating speed and power to cut vegetation.

According to advantageous but optional aspects, such a head may incorporate one or more of the following features, considered alone or according to any technically allowable combination:
the wall is part of a closing member of the head and the rotation axis of the at least one bearing is parallel to the spinning axis;
the wall is a peripheral wall and the rotation axis of the at least one bearing is radial to the spinning axis;
the at least one eyelet includes two or more eyelets that are regularly spread around the spinning axis;
the at least one bearing includes rolling element bearing;
the at least one bearing includes a slide bearing;
the at least one bearing is integral with the wall at the at least one eyelet;
the at least one bearing comprises an outer ring with a shoulder, the shoulder cooperating with the wall and being configured to prevent translation movement of the at least one bearing along the rotation axis outward the spinning axis;
the blocking member of the at least one sub-assembly is integral with the one or more cutting strings of the at least one sub-assembly and includes an protrusion from the rest of the cutting string;
the at least one blocking member comprises a ring with an opening, the cutting string passing through the opening, and wherein the ring has an outer dimension that is bigger that an inner diameter of the at least one bearing;
the at least one blocking member comprises a bearing portion and a holding portion, wherein the bearing portion cooperates with the at least one bearing so that the holding member is rotatable without restriction with respect to the wall around the rotation axis of the at least one bearing, and wherein the holding portion is extending outside the head and is configured to hold the cutting string;
the holding portion comprises an opening, which is located outward the wall of the head relative to the spinning axis and is configured to hold the cutting string;
the holding portion comprises a spool, configured to hold a coil of the cutting string;
the holding portion axis is aligned with the rotation axis of the bearing, and
the holding portion is eccentric relative to the rotation axis of the bearing.

The invention also relates to a string trimmer, comprising:
a frame, with a lower extremity defining a spinning axis, and
a head, which is linked to the lower extremity of the frame and which is driven in rotation around the spinning axis by a power organ, wherein the head is as defined previously.

### BRIEF DESCRIPTION OF THE DRAWINGS

The invention will be better understood, and other advantages thereof will appear more clearly, in light of the following description of six embodiments of a head of a string trimmer provided solely as a non-limiting example and done in reference to the appended drawings, in which:

FIG. 1 is a schematic side view of a string trimmer, comprising a head according to a first embodiment of the invention;

FIG. 2 is a cut view of the head of FIG. 1, according to a plane II shown on FIG. 1;

FIG. 3 is a view similar to FIG. 2, showing at higher scale a head of a string trimmer according to a second embodiment of the invention;

FIG. 4 is a view similar to FIG. 2, showing a head of a string trimmer according to a third embodiment of the invention;

FIG. 5 is a view similar to FIG. 2, showing a head of a string trimmer according to a fourth embodiment of the invention;

FIG. 6 is a view similar to FIG. 2, showing a head of a string trimmer according to a fifth embodiment of the invention; and

FIG. 7 is a view similar to FIG. 2, showing a head of a string trimmer according to a sixth embodiment of the invention.

### DETAILED DESCRIPTION

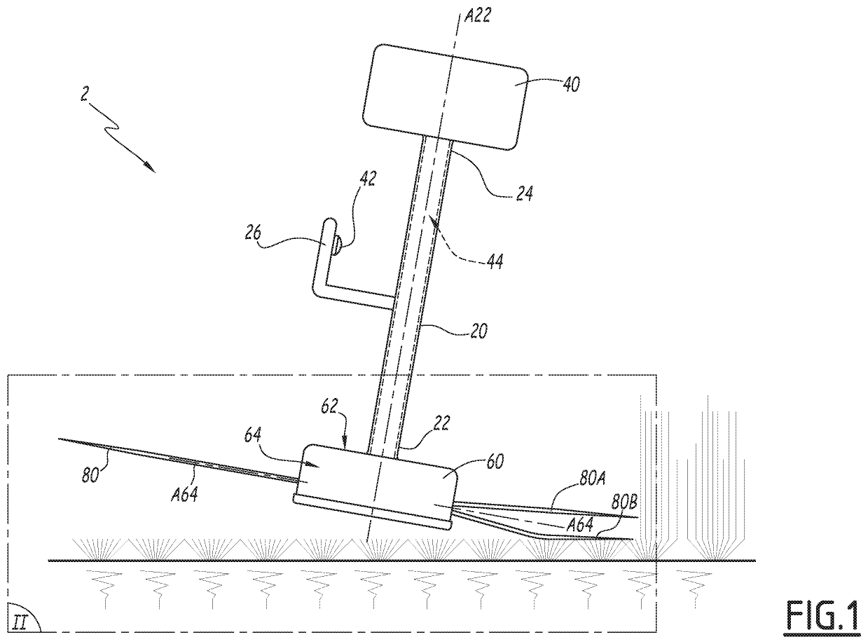

A string trimmer 2 is schematically represented on FIG. 1. The string trimmer 2 is an apparatus configured to cut vegetation such as grass, foliage or bushes, using flexible cutting strings instead of rigid blades. The strings are attached to a head that spins at high speed, so that the strings become rigid under the centrifugal forces generated by the spinning movement of the head. The impact of the moving strings with the vegetation is violent enough to cut the vegetation. Since the strings are flexible, the strings will not damage masonry elements such as lawn borders, making such string trimmer very suitable for finishing work.

Within the present description, unless mentioned otherwise the term “trimmer” refers to a string trimmer, and the term “string” refers to a cutting string, used with a string trimmer.

Trimmer 2 includes a frame 20, a power organ 40 and a head 60.

Frame 20 has an elongated shape with two opposite extremities 22 and 24. In the illustrated example, extremity 22 is close to the ground in use, and is therefore also referred to as “lower extremity” 22.

Head 60 is linked to lower extremity 22 of frame 20 with a rotation freedom around an axis A22, which is referred to as a “spinning axis”. In the illustrated example, frame 20 has a straight shape and spinning axis A22 is parallel to a longitudinal direction of frame 20. In other examples, frame 20 has a curved shape, or may include flexible portions.

A holding member 26 is managed on frame 20 at a distance from lower extremity 22 so that a standing user can hold holding member 26 while lower extremity 22 is close to the ground level. In the illustration of FIG. 1, holding member 26 is a handle.

Power organ 40 is linked to head 60 and is configured to drive head 60 in rotation relative to frame 20 around spinning axis A22 when a user activates power organ 40 by means of a switch 42. In the illustrated example, switch 42 is located on holding member 26, so that a user may, with one hand, hold holding member 26 and activate or de-activate power organ 40.

In the illustration of FIG. 1, power organ 40 is an engine powered by fuel. Alternatively, power organ 40 is an electric motor, powered by batteries or connected to an electric power outlet by means of a power cord.

In the illustrated example, power organ 40 is attached to frame 20 at extremity 24 and drives head 60 in rotation relative to frame 20 around spinning axis A22 by means of a shaft 44, which is received inside an internal volume of frame 20. According to other embodiments, power organ 40 is attached to frame 20 at lower extremity 22 and shaft 44 may be replaced by a gearbox or the like. When power organ 40 is an electric motor, the stator can be attached to frame 20, while the rotor may be integrated with head 60, in a so-called “direct drive” configuration. In other embodiments, power organ 40 is carried by a user on his back, and shaft 44 includes a flexible portion, which is arranged within a corresponding flexible portion of frame 20.

More generally, whichever the configuration of string trimmer 2, head 60 is driven in rotation with respect to frame 20 by power organ 40 around spinning axis A22. This rotation movement of head 60 around spinning axis A22 is henceforth referred to as “spinning movement”.

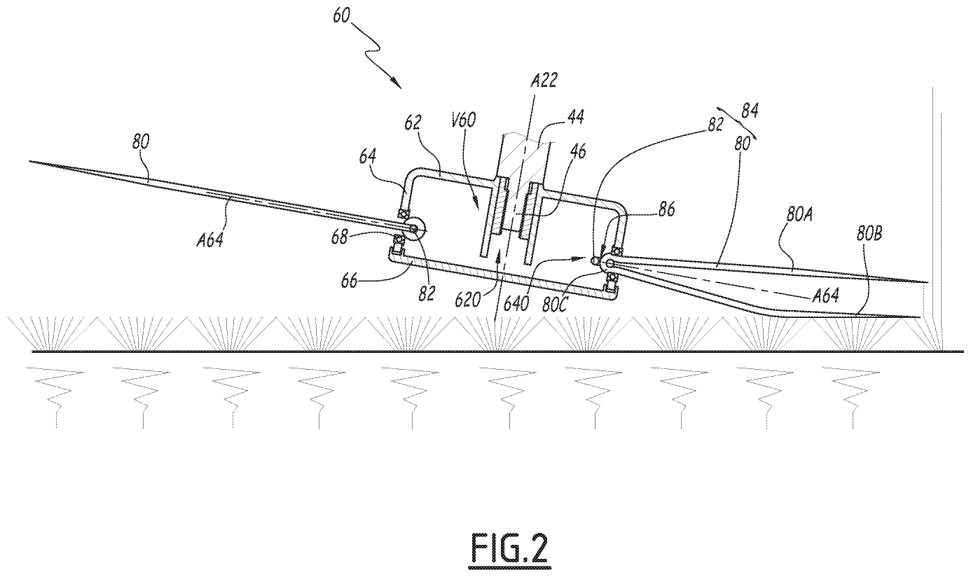

In the illustration of FIG. 2, shaft 44 is partially visible, while frame 20 is omitted.

Head 60 has an overall shape of a cylindrical box oriented downwards, with a circular section aligned with spinning axis A22. The bottom of the box defines a hub portion 62 of head 60, the sides of the box define a peripheral wall 64 and a lid of the box defines a closing member 66. Hub portion 62 is disc-shaped and extends radially relative to spinning axis A22.

In the illustrated example, shaft 44 includes a threaded end-piece 46, which is aligned with spinning axis A22, and hub portion 62 includes a central opening 620 with a threaded portion, which cooperates with end-piece 46 of shaft 44, so that hub portion 62 is linked to power organ 40.

Peripheral wall 64 is a portion of a cylinder with a circular section centered on spinning axis A22. Peripheral wall 64 extends from an outer edge of hub portion 62 and defines, with hub portion 62, a cavity V60 of head 60. Cavity V60 is closed by closing member 66. Closing member 66 is assembled to peripheral wall 64 by locking means, not shown, which are reversible so that a user can access cavity V60, for example, to unmount head 60 from shaft 44. Closing member 66 is optional for the invention to work, but closing member 66 prevents dirt from entering cavity V60.

End-piece 46 and closing member 66 are configured to remain fastened respectively to hub portion 62 and the rest of head 60 when head 60 is driven in rotation by power organ 40.

One or more eyelets 640 are managed in peripheral wall 64. Each eyelet 640 preferably has a circular shape centered on a respective axis A64, which is mainly oriented radially relatively to spinning axis A22.

At least one eyelet 640 is fitted with a respective bearing 68, which rotates with respect to peripheral wall 64 around axis A64 of the corresponding eyelet 640. In other words, each eyelet 640 is oriented so that a rotation axis A64 of bearing 68 arranged in eyelet 640 is mainly radial to spinning axis A22 of head 60.

In the illustrated examples, head 60 includes two eyelets 640 located opposite to each other relatively to spinning axis A22, each eyelet 640 receiving a bearing 68. Although the invention works with only one bearing 68, head 60 preferably includes two or more bearings 68, each received in a respective eyelet 640 managed in peripheral wall 64, bearings 68 preferably being regularly spread in peripheral wall 64 around spinning axis A22, so that a center of inertia of head 60 is borne by spinning axis A22. Such configuration leads to a better balance of head 60, with reduced vibrations, when head 60 is spinning at high speed around spinning axis A22. Bearings 68 are preferably of the same type and identical to each other.

In the illustrated example, peripheral wall 64 extends 360° around spinning axis A22, eyelets 640 being the sole openings through peripheral wall 64. Alternatively, peripheral wall 64 is a partial wall that includes other openings, not shown, that are different from eyelets 640 and that may be arranged for other purposes, such as weight or material cost reduction, or to facilitate replacement of a worn cutting string, as explained later in the present description.

In the illustrated example, bearings 68 have rolling elements 686. More precisely, rolling elements 686 are balls, and bearings 68 are ball bearings. Alternatively, rolling elements 686 are rollers and bearings 68 are roller bearings.

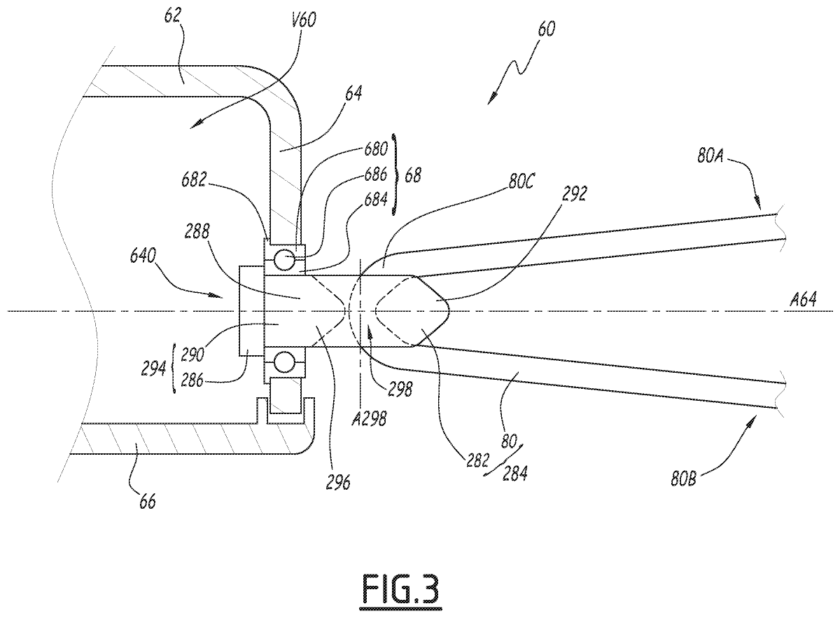

A bearing 68 is visible at higher scale in FIG. 3. Each bearing 68 includes an outer ring 680, with a shoulder 682 that cooperates with peripheral wall 64 and that is configured to prevent translation movements of outer ring 680 along rotation axis A64. In particular, when head 60 is spinning, translation movements outward of spinning axis A22 are prevented. Each bearing 68 also includes an inner ring 684, which rotates without restriction relative to peripheral wall 64 around corresponding rotation axis A64.

Alternatively, bearings 68 may be of the slide bearing type, in other words a bearing with an outer ring 680 but with no inner ring. Outer ring 680 is lubricated and rotates slidingly without restriction relative to peripheral wall 64 around rotation axis A64. In any case, each bearing 68 includes a ring that rotates without restriction relative to peripheral wall 64 around a corresponding rotation axis A64. The following description is given relative to a ball bearing as illustrated on the figures, where the rotating ring is inner ring 684.

Each bearing 68 receives a cutting string 80 and a blocking member 82 configured to hold cutting string 80, so that a sub-assembly 84 consisting of a blocking member 82 and a cutting string 80 is rotatable without restriction in relation to peripheral wall 64 along rotation axis A64 of corresponding bearing 68.

In the present description, the expression “without restriction” refers to the fact that the amplitude of the rotation movement of sub-assembly 84 around rotation axis A64 is not prevented by any specific device.

Of course each sub-assembly 84 and corresponding bearing 68 are subject to friction forces, such as aerodynamic forces or contact forces between sub-assembly 84 and corresponding bearing 68. When bearing 68 is a roller bearing, bearing 68 is also subject to internal friction forces between outer ring 680 and rolling elements 686, and between inner ring 684 and rolling elements 686.

Cutting strings 80 are managed in a flexible material, such as a synthetic or a natural polymer, that offer good pulling strength, in order to resist the centrifugal forces generated when head 60 is spinning, and offer good abrasion resistance. Such materials may include, but are not limited to, nylon strings, reclaimed tennis racquet strings, catgut, etc. Cutting strings 80 may have a circular transversal section, or any specific geometric section such as a square or a pentagonal section, in order to improve the cutting effect of a new cutting string 80.

In the illustrated examples, each cutting string 80 includes two end portions 80A and 80B, and an intermediate portion 80C located between end portions 80A and 80B.

In the illustration of FIG. 2, blocking members 82 are ring-shaped. As a non-limitative example, blocking members 82 are washers, which are cheap and easy to supply.

Each blocking member 82 has an outer dimension that is larger than an inner diameter of bearings 68, so that blocking member 82 cannot pass through bearing 68. Blocking member 82 is located inside cavity V60, while cutting string 80 passes through an opening 86 of blocking member 82 and is folded in two at intermediate portion 80C, so that end portions 80A and 80B extend outside head 60. Thanks to such configuration of head 60, end portions 80A and 80B of each cutting string 80 are used to cut the grass.

When head 60 is spinning around spinning axis A22, cutting strings 80 are pulled outward of head 60 by centrifugal forces, and blocking member 82 is in contact with corresponding bearing 68, as shown in FIG. 2.

Preferably, intermediate portion 80C is in the middle between end portions 80A and 80B, in other words, the two portions between intermediate portion 80C and respectively each end portion 80A and 80B are of equal length, so that the centrifugal forces exerted on string 80 by the two portions are equilibrated, and cutting string 80 does not tend to slide relatively to blocking member 82.

In the illustrated example, each cutting string 80 is simply passing through opening 86 of corresponding blocking member 82, so that a user may easily replace a worn or broken cutting string 80 without using any tool when closing member 66 is removed from head 60.

Preferably, opening 86 of blocking member 82 has sharp angles, such as a thread, which penetrates in cutting string 80 when cutting string 80 is pulled by centrifugal forces as head 60 is spinning around spinning axis A22.

In other embodiments, an internal diameter of opening 86 is slightly smaller than a diameter of cutting string 80, so that a user may attach string 80 to a blocking member 82 simply by pulling string 80 through opening 86, string 80 being deformed so that the string remains in place.

Alternatively, blocking member 82 include locking elements, for example a pressure screw, not shown, managed in the fastening member, in order to securely attach string 80 to blocking member 82. In such a case, intermediate portion 80C may be offset from the middle of string 80, or string 80 may be attached by one of end portions 80A or 80B to blocking member 82, for example, end portion 80A, while solely the other end portion, for example, end portion 80B, extends outward of head 60.

When a user activates power organ 40 in order to trim vegetation such as grass or foliage, as head 60 is spinning around spinning axis A22, cutting strings 80 enter in contact with the vegetation to be cut and/or with obstacles such as the ground, stones or a tree's root. In addition to the centrifugal forces, each string 80 is submitted to the contact forces of end portions 80A and 80B with the grass and/or obstacles. As the contact forces exerted on each end portion 80A and 80B are different, the contact forces generate a rotation torque on string 80 and on blocking member 82 holding the string. Since sub-assembly 84 is movable in rotation without restriction with respect to peripheral wall 64 around rotation axis A64, sub-assembly 84 starts rotating with respect to peripheral wall 64 around rotation axis A64 of bearing 68.

In FIG. 2, head 60 is spinning around spinning axis A22 and sub-assembly 84 around rotation axis A64. The working end portion 80B of cutting string 80 is represented in contact with the grass. Thanks to the invention, a significant part of end portion 80B, moved by the new centrifugal force, lays down on the grass to be cut or evade easily by rotating when coming into contact with an obstacle too hard to cut or too heavy to be moved. That increases working area and causes an abrasion that is spread on all sides of cutting strings 80. This abrasion favorably tapers end portions 80A and 80B, increasing the cutting capacity of string 80, which in turn requires lower rotating speed and power to cut vegetation. If end portion 80B enters in contact with an obstacle, such as a stone or a tree's root, the instantaneous speed of end portion 80B decreases while end portion 80A accelerates, thanks to the rotation freedom of sub-assembly 84 around rotation axis A64. In other words, extremity 80B evades partially upwards the obstacle, therefore reducing the damage incurred by extremity 80B when impacting the obstacle.

More generally, as sub-assembly 84 rotates without restriction around rotation axis A64, cutting string 80 will evade all obstacles that cannot be cut or moved, thus increasing the service life of cutting string 80. Furthermore, as the rotation of sub-assembly 84 around the rotation axis A64 is random, the contact location of end portions 80A or 80B with the grass or with any obstacle is random. Since cutting strings 80 incur wear upon entering in contact with grass or any obstacle, the wear of the string is, as a result, more evenly spread at the periphery of cutting string 80 compared to the prior art situation, where the cutting strings are not free to rotate around an axis radial to spinning axis A22, and where the wear is more localized on one side of the string's end and tends to break prematurely the cutting string. A better-spread wear along cutting string 80 reduces the risk of an early break for the cutting string 80. In FIGS. 1, 2 and 4, end-portions 80A and 80B are represented with pointed extremities so as to illustrate the observed effect of a better-spread wear of strings 80 and requirement of lower rotating speed and power to cut vegetation.

FIG. 3 shows an alternative, second embodiment of head 60 according to the invention. In this embodiment, the parts of head 60 identical or similar to the ones of the first embodiment have the same reference numerals. Hereafter, mainly the differences between the first and second embodiments are detailed.

In the second embodiments of the invention, a blocking member 282 has a different shape compared to blocking member 82 of the first embodiment, so that a user can replace cutting string 80 without having to access cavity V60 of the head 60. Blocking member 282 cooperates with a bearing 68. Blocking member 282 and cutting string 80 together form a sub-assembly 284, which is rotatable without restriction in relation to peripheral wall 64 along rotation axis A64 of bearing 68.

In the example illustrated in FIG. 3, each blocking member 282 has a shape similar to a nail, with a head 286 attached to a pin 288. Pin 288 passes through bearing 68 and extends outward of head 60, while head 286 is located inside of head 60 and cooperates with inner ring 684 of bearing 68, so as to prevent translation movements of blocking member 282 along rotation axis A64 outward of spinning axis A22.

Head 286 has a flat cylindrical shape with a circular section centered on rotation axis A64 of bearing 68. Head 286 has an external diameter greater than the inner diameter of bearing 68, and is located inside cavity V60. Head 286 cooperates with bearing 68 to prevent blocking member 282 from passing through bearing 68, while allowing blocking member 282 to rotate without restriction with respect to peripheral wall 64 around rotation axis A64 of bearing 68.

Pin 288 has an elongated cylindrical shape along rotation axis A64 of bearing 68, with two extremities 290 and 292 opposite each other, the first extremity 290 being attached to head 284 and the second extremity 292 being located outside of cavity V60 outward of spinning axis A22.

Head 286 and first extremity 290 of pin 288 together define a bearing portion 294 of blocking member 282, and the portion of pin 288 extending outside of head 60 defines a holding portion 296 of blocking member 282.

An opening 298 is managed in holding portion 296, along an axis A298 that is orthogonal to rotation axis A64. Opening 298 is configured to receive a cutting string 80.

In the illustrated example, each cutting string 80 is simply passing through opening 298 of corresponding blocking member 282, so that a user may easily replace a worn or broken cutting string 80 without use of any tool.

Preferably, an internal diameter of opening 298 is slightly smaller than the diameter of cutting string 80, so that a user may attach string 80 to holding portion 296 simply by pulling string 80 through opening 298, string 80 being deformed so that the string remains in place.

In other words, bearing portion 294 cooperates with bearing 68 so that blocking member 282, and therefore sub-assembly 284, is rotatable without restriction relative to peripheral wall 64 along rotation axis A64 of the bearing 68.

When head 60 is spinning, cutting string 80 folds under the effect of centrifugal forces, and end portions 80A and 80B, when entering into contact with obstacles, tend to evade the obstacles by a rotation movement of sub-assembly 284 around rotation axis A64.

In the illustrated example, holding portion 296 of blocking member 282 is aligned with rotation axis A64 of bearing 68, so that sub-assembly 284 has a mass distribution that is sensibly evenly spread around rotation axis 64. As a result, end-portions 80A and 80B have a similar influence on the tendency of sub assembly 284 to start rotating with respect to peripheral wall 64 around rotation axis A64.

Alternatively, second extremity 292 is not aligned on rotation axis A64; in other words, holding portion 296 is eccentric relative to rotation axis A64 of bearing 68, so that an imbalance is created between end-portions 80A and 80B, and the tendency for sub-assembly 284 to start rotating around rotation axis A64 when entering into contact with an obstacle is stronger, leading to better obstacle evasion and better spread wear along cutting string 80.

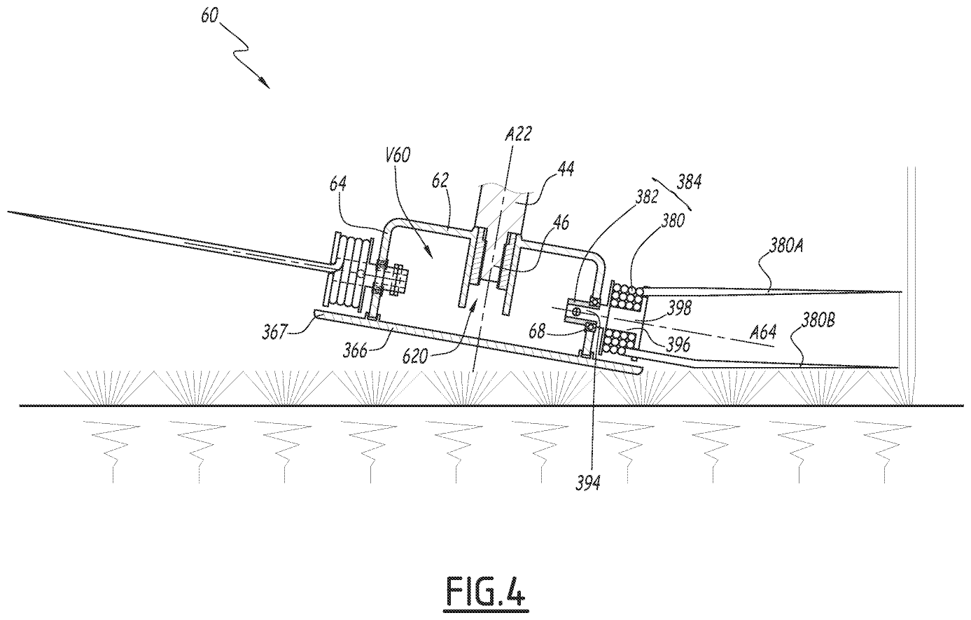

FIG. 4 shows an alternative, third embodiment of a head 60 according to the invention. Hereafter, mainly the differences between the third embodiment and the previous embodiments are detailed.

Head 60 of the third embodiment includes at least one blocking member 382, the at least one blocking member 382 including a bearing portion 394 that is received by a respective bearing 68, so that blocking member 382 is rotatable without restriction with respect to peripheral wall 64 around rotation axis A64 of the bearing 68. Each blocking member 382 also includes a holding portion 396, which extends outward of peripheral wall 64 and includes a spool 398. Spool 398 is configured to hold a coil of cutting string 380. Spool 398, holding the coil of cutting string 380, is rotatable without restriction with respect to peripheral wall 64 around the corresponding rotation axis A64. Two end portions 380A and 380B of cutting string 380 extend beyond spool 398 outward of spinning axis A22.

Blocking member 382 and the coil of cutting string 380 define together a sub-assembly 384, which is rotatable without restriction with respect to peripheral wall 64 around rotation axis A64 of the corresponding bearing 68. When head 60 rotates around spinning axis A22, end portions 380A and 380B may enter in contact with obstacles, causing sub-assembly 384 to rotate around rotation axis A64. In a way similar to the first and second embodiments, end portions 380A and 380B partially evade the obstacles, and the wear of cutting string 380 is spread more evenly along end portions 380A and 380B. The service life of cutting strings 380 is longer. Furthermore, if one of end portion 380A or 380B is shortened due to wear or a break, a user may pull the shortened end portion 380A or 380B so as to increase the length of the shortened end portion up to the desired length, without having to replace the whole cutting string 380.

In the third embodiment, head 60 is closed by means of a closing member 366. Closing member 366 includes peripheral portions 367, which extends outward of peripheral wall 64 radially to spinning axis A22, peripheral portions 367 being configured to protect spools 398 from obstacles such as stones or grass.

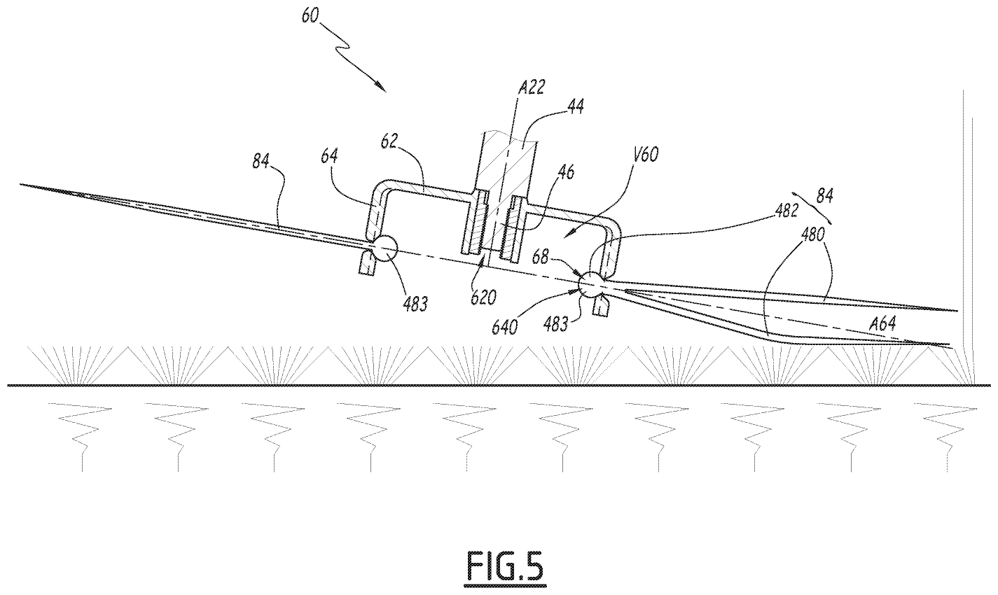

FIG. 5 shows an alternative, fourth embodiment of a head 60 according to the invention. Hereafter, mainly the differences between the fourth embodiment and the previous embodiments are detailed.

One of the main differences of the fourth embodiment with the previous embodiments is that head 60 of the fourth embodiment is made out of a material with low friction coefficient, so that the bearings are integral with the peripheral wall at the eyelets. Another difference is that for each sub-assembly, the blocking member is integral with the cutting string.

Preferably one of the parts of head 60 of the fourth embodiment is made out of a synthetic material that is both lightweight and wear resistant, such as Nylon.

In order to reduce further the friction coefficient between sub-assembly 84 and bearing 68, the synthetic material of head 60 includes advantageously a charge, in powder form, that has lubricating properties. An example of such a lubricating powder is molybdenum disulfide. An example of Nylon charged with molybdenum disulfide is commercialized under the name “Nylatron”.

Each sub-assembly 84, received in corresponding eyelet 640, is rotating around corresponding rotation axis A64. Sub-assembly 84 is directly in contact with peripheral wall 64; in other words, eyelet 640 acts as a bearing 68 that is integral with peripheral wall 64.

Favorably no extra part such as a ball bearing is required, which lowers the manufacturing cost of head 60.

In the fourth embodiments, head 60 does not include an equivalent of closing portion 66 of the previous embodiments. This allows for better cooling of the inside of head 60 and for easier replacement of sub-assembly 84 when cutting strings 80 are worn out.

Each sub-assembly 84 of the fourth embodiment includes cutting strings 480, which extend along sensibly the same direction from a protrusion 483. Protrusion 483 has an external dimension that is greater that an internal dimension of eyelet 640, so that protrusion 483 cannot pass through eyelet 640. In the example shown in FIG. 5, protrusion 483 has a spherical shape.

Cutting strings 480 extend outward of peripheral wall 64 radially to spinning axis A22 when head 60 is driven in rotation around spinning axis A22, while protrusion 483 is located inward relative to peripheral wall 64. In other words, protrusion 483 is a blocking member 482 for sub-assembly 84, and blocking member 482 of sub-assembly 84 is integral with cutting strings 480 of the sub-assembly 84 and includes a protrusion from the rest of the cutting string.

Alternatively, head 60 of trimmer 2 is made of metal, such as steel or aluminum, and only cutting string 80, which includes the protrusion, are made out of synthetic material that includes a charge with lubricating properties.

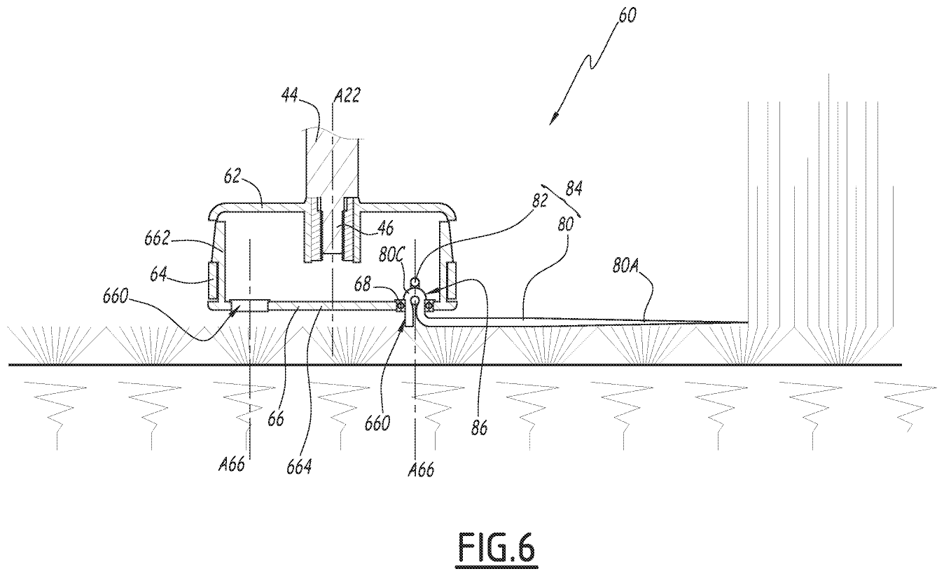

FIG. 6 shows an alternative, fifth embodiment of a head 60 according to the invention. Hereafter, mainly the differences between the fifth embodiment and the previous embodiments are detailed. In the fifth embodiment, the bearings are arranged within a wall that is part of closing member 66 of head 60 rather than within peripheral wall 64, as in the other embodiments.

Closing member 66 includes a fastening portion 662, which cooperates with peripheral wall 64 in order to attach closing member 66 to the rest of head 60, and a wall 664, which extends orthogonally to spinning axis A22.

Wall 664 of closing member 66 is provided with at least one eyelet 660. Each eyelet 660 has preferably a circular shape centered on a respective axis A66, which is mainly oriented parallel to spinning axis A22.

At least one eyelet 660 is fitted with a respective bearing 68, which rotates with respect to closing member 66 around axis A66 of corresponding eyelet 66. In other words, each eyelet 660 is oriented so that a rotation axis A66 of bearing 68 arranged in the eyelet 660 is mainly parallel to spinning axis A22 of head 60.

In the illustrated examples, head 60 includes two eyelets 660 located opposite to each other relatively to spinning axis A22. One eyelet 640 receives a bearing 68 while the other eyelet 660 is represented empty.

Although the invention works with only one bearing 68, head 60 preferably includes two or more bearings 68, each received in a respective eyelet 660 managed in wall 664. When head 60 includes two or more bearings 68, the bearings are preferably regularly spread in wall 664 around spinning axis A22, so that a center of inertia of head 60 is borne by spinning axis A22. Such configuration leads to a better balance of head 60, with reduced vibrations, when head 60 is spinning at high speed around spinning axis A22. Bearings 68 are preferably of the same type and identical to each other.

Bearings 68 used for head 60 of the fifth embodiment are similar to the bearings used for the first embodiments, only the orientation of rotation axis A66 of each eyelet 660, parallel to spinning axis A22, is different with the orientation of rotation axis A64 of each eyelet 640 of the first embodiment, wherein rotation axis A64 is radial to spinning axis A22.

Similarly to the other embodiments, each bearing 68 receives one sub-assembly 84 including a cutting string 80 and a blocking member 82 configured to hold cutting string 80, so that sub-assembly 84 is rotatable without restriction in relation to the rest of head 60 along rotation axis A64 of corresponding bearing 68.

Said otherwise, wall 664 is provided with at least one eyelet 660, and at least one bearing 68 is received in the at least one eyelet 660 and defines a rotation axis A66. At least one sub-assembly 84 including a blocking member 82 and a cutting string 80 that is held by blocking member 82 so as to extend outward of wall 664 radially to spinning axis A22 when head 60 is trained in rotation around spinning axis A22, the at least one sub-assembly 84 being received by the at least one bearing 68 so that sub-assembly 84 is rotatable without restriction around rotation axis A66 of the at least one bearing 68 with respect to wall 664.

In the fifth embodiment, each rotation axis A66 is not aligned with spinning axis A22, so that when head 60 spins around spinning axis A22, strings 80 become rigid under centrifugal forces and become suitable to cut vegetation such as grass or bushes.

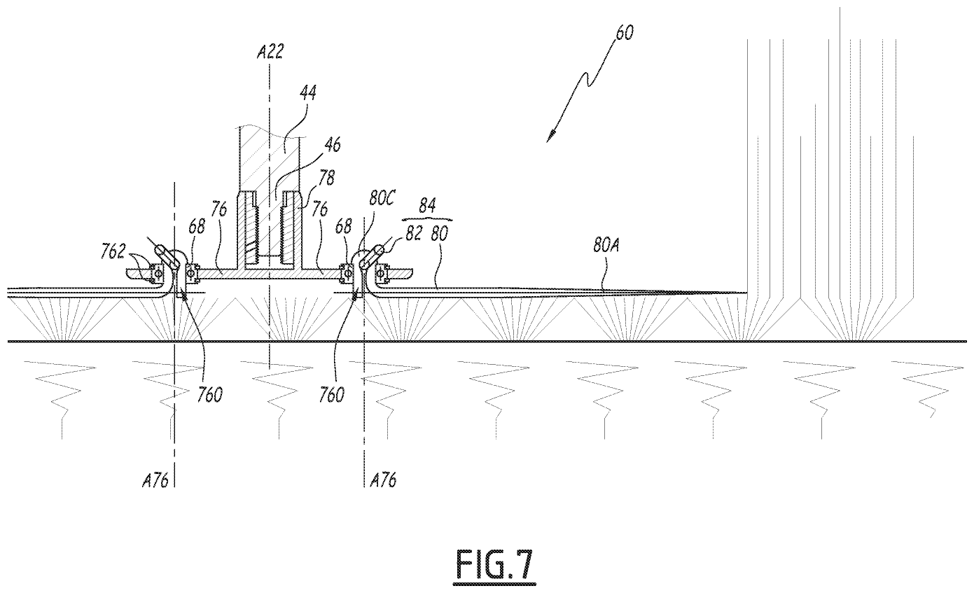

FIG. 7 shows an alternative, sixth embodiment of a head 60 according to the invention. Hereafter, mainly the differences between the sixth embodiment and the previous embodiments are detailed. Head 60 of the sixth embodiment has a simpler structure compared to the previous embodiments, head 60 including a wall 76 that is in the same position as closing member 66 of the fifth embodiment; however, head 60 also includes a mounting portion 78, that cooperates with end-piece 46 so as to immobilize head 60 relative to the shaft 44.

In the illustrated example, wall 76 is disc-shaped, is arranged radially to spinning axis A22 and is provided with two eyelets 760. Each eyelet 760 receives one bearing 68 and defines a rotation axis A76. In the illustrated example, each rotation axis A76 is parallel to, but not aligned with, spinning axis A22 of head 60. Each bearing 68 is held in place within the respective eyelet 760 by fixing means 762 that are preferably reversible, so as to replace, when needed, a worn bearing 68. In the illustrated example, the fixing means 762 are retaining rings such as “circlips”.

Each bearing 68 receives a sub-assembly 84, including a blocking member 82 and a cutting string 80 that is held by blocking member 82 so as to extend toward the ground when string trimmer 2 is in use; in other words, so as to extend outward of wall 76. When head 60 is trained in rotation around spinning axis A22, strings 80 are subject to centrifugal forces and extend radially to spinning axis A22. Each sub-assembly 84 is received by one bearing 68 so that sub-assembly 84 is rotatable without restriction around rotation axis A76 of the at least one bearing 68 with respect to wall 76.

More generally, head 60 can have any shape, as long as head 60 includes a wall that is provided with at least one eyelet, the at least one eyelet receiving one bearing defining a rotation axis that is not aligned with spinning axis A22 of head 60. The rotation axis is preferably oriented opposite to extremity 24 of frame 20, so that cutting strings 80 are oriented towards the ground when trimmer 2 is in use.

In an alternative, not shown embodiment, head 60 is conical, or includes a portion with a truncated conical shape, which points opposite to extremity 24 of frame 20, the conical portion including a peripheral wall that is provided with the eyelets receiving one bearing each. In the fifth and sixth embodiments, each string 80 has only one end-portion extending outward of closing portion 66.

In the illustrated embodiments, each cutting string 80 has one or two end portions 80A and 80B extending outward of head 60. In an alternative not shown embodiment, each cutting string 80 has three or more end portions extending outward of peripheral wall 64.

More generally, the number of end-portions of each cutting string 80 is not limited, as long as each cutting string 80 does not prevent the rotation of sub-assembly 84 around rotation axis A64 or A66 of the respective bearing 68. When each cutting string 80 has two end-portions or more, the length of each end-portion may be different, for example when an end-portion of a cutting string 80 breaks because of the wear, or when replacing a worn cutting string 80 by a new cutting string 80.

The respective features of the head of a string trimmer and a string trimmer comprising such a head and embodiments considered in the description can be combined.

1. Head of a string trimmer, the head being rotatably trained around a spinning axis, the head comprising:
a wall comprising at least one eyelet;
at least one bearing, which is received in said at least one eyelet and which defines a rotation axis; and
at least one sub-assembly comprising:
a blocking member; and
a cutting string that is held by said blocking member so as to extend outward of said wall radially to the spinning axis when the head is trained in rotation around the spinning axis, said at least one sub-assembly being received by said at least one bearing so that said at least one sub-assembly is rotatable without restriction around the rotation axis of said at least one bearing with respect to said wall.

2. Head of a string trimmer according to claim 1, wherein said wall is part of a closing member of the head and wherein the rotation axis of said at least one bearing is parallel to the spinning axis.

3. Head of a string trimmer according to claim 1, wherein said wall is a peripheral wall of the head, and wherein the rotation axis of said at least one bearing is radial to the spinning axis.

4. Head of a string trimmer according to claim 1, wherein said at least one eyelet comprises two or more eyelets that are regularly spread around the spinning axis.

5. Head of a string trimmer according to claim 1, wherein said at least one bearing comprises at least one rolling element bearing.

6. Head of a string trimmer according to claim 1, wherein said at least one bearing comprises at least one slide bearing.

7. Head of a string trimmer according to claim 6, wherein said at least one bearing is integral with said wall at said at least one eyelet.

8. Head of a string trimmer according to claim 1, wherein said at least one bearing comprises an outer ring with a shoulder, the shoulder cooperating with said wall and being configured to prevent translation movement of said at least one bearing along the rotation axis outward of the spinning axis.

9. Head of a string trimmer according to claim 1, wherein said blocking member of said at least one sub-assembly is integral with said at least one cutting string of said at least one sub-assembly and comprises a protrusion from the rest of said at least one cutting string.

10. Head of a string trimmer according to claim 1, wherein said at least one blocking member comprises a ring with an opening, said at least one cutting string passing through the opening, and wherein said ring has an outer dimension that is bigger that an inner diameter of said at least one bearing.

11. Head of a string trimmer according to claim 1, wherein each of said at least one blocking member comprises:
a bearing portion; and
a holding portion,
wherein said bearing portion cooperates with said at least one bearing such that said holding portion is rotatable without restriction with respect to said wall around the rotation axis of said at least one bearing, and wherein said holding portion extends outside of the head and is configured to hold said cutting string.

12. Head of a string trimmer according to claim 11, wherein said holding portion comprises an opening, which is located outward said wall of the head with respect to the spinning axis and is configured to hold said cutting string.

13. Head of a string trimmer according to claim 11, wherein said holding portion comprises a spool, configured to hold a coil of said cutting string.

14. Head of a string trimmer according to claim 11, wherein an axis of said holding portion is aligned with the rotation axis of said at least one bearing.

15. Head of a string trimmer according to claim 11, wherein said holding portion is eccentric relative to the rotation axis of said at least one bearing.

16. A string trimmer, comprising:
a frame, comprising a lower extremity defining a spinning axis, and
a head according to claim 1, which is linked to said lower extremity of said frame, and which is driven in rotation around the spinning axis by a power organ.
